(19) United States
(12) Patent Application Publication
(10) Pub. No.: US 2015/0379596 A1
(43) Pub. Date: Dec. 31, 2015

(54) SYSTEM AND METHOD FOR MATCHING BUYERS AND SELLERS

(71) Applicant: Zhuangzi Li, Sunnyvale, CA (US)

(72) Inventor: Zhuangzi Li, Sunnyvale, CA (US)

(21) Appl. No.: 14/318,581

(22) Filed: Jun. 28, 2014

(51) Int. Cl. G06Q 30/06; G06Q 10/08

(52) U.S. Cl. CPC G06Q 30/0605; G06Q 30/0635; G06Q 10/083

(57) ABSTRACT

A system for matching buyers and sellers, and in particular, a system that matches database representations of purchase “Intentions” from one or more buyers with items listed as available in a database representing sellers' inventory. In some embodiments, the buyers' Intentions are pooled into a “Groupbuy” that a single Seller can fulfill.

In some embodiments, the system employs matching algorithms to match individual Buyers (or pooled Buyers in a Groupbuy) with Sellers.

In some embodiments, an individual Buyer may initiate a Groupbuy, and other Buyers may join the Groupbuy without the execution of any matching algorithms.

In some embodiments, the system additionally manages payment transactions, and provides vouchers to the Buyers to certify they have paid and can take delivery of the purchased product.

In some embodiments, the system is implemented on a central server and buyers and sellers access portions of the data through the Internet.

### CROSS-REFERENCE TO RELATED APPLICATIONS

None.

### FIELD OF THE INVENTION

This invention relates to the field of online commerce, and in particular, presents a system in which buyers can enter “Intentions” for purchasing items. These intentions are then pooled into a “Groupbuy”, and matched to seller inventory information. Unlike other online commerce systems, embodiments of the system disclosed here use a reverse auction mechanism to optimize discounts for Buyers and surpluses for Sellers. In some embodiments, registration with the system includes a commitment that the establishment of a match by the system will constitute a binding contract between individual buyers and sellers. In some embodiments, a purchase order generated by the system is then fulfilled through a system of payments and vouchers.

### BACKGROUND OF THE INVENTION

In markets since the beginning of history, there have been several possible arrangements for bringing buyers and sellers together. In a traditional market, sellers come to the marketplace, often in a central town square, and offer their wares and goods for buyers to inspect and buy on a designated market day. Individual buyers come to the market and shop among the stalls, and discussions between buyers and sellers over the quality and price of the goods take place directly. If an agreement is reached, the buyer pays money to the seller and departs with the goods. This market sale is generally a one-to-one (seller to buyer) process, taking place in a many-to-many marketplace.

Stores offer a more formal variation on this kind of marketplace. A street or mall of shops may offer a variety of products, and larger stores, such as Bloomingdales or Macy's, may have several departments that offer a wide variety of goods. The store, however, generally conducts business by allowing buyers to shop among displays of goods, and the individual buyer still makes a one-to-one purchase from an individual seller, which in this case is now a corporate entity (the store).

An alternative to the marketplace is the auction house, such as Sotheby's. Here, individual items are presented by a seller to a number of interested buyers, and the buyers may bid for an item they wish to acquire. The seller selects the buyer based on certain criteria (the highest bid, the best credit, etc.) and the transaction concludes. The auction sales model is a one-to many (one seller to many buyers) process.

An additional alternative can be found in the existence of cooperatives, or co-ops. Co-ops generally pool buyers into a group, which then has the financial resources to buy large numbers of items or very expensive items, often at a group discount. Such co-ops are often found in agricultural communities, where a co-op may purchase farming equipment shared by the community, or may own and operate grain elevators where the co-op members pool their grain before sale and shipping. Some retail stores, such as Recreational Equipment, Inc. (REI) of Kent, Wash., are also structured as consumer cooperatives, buying products at wholesale prices and giving members a dividend based on annual sales. The co-op sales model is a many-to-one process (many sellers to a single collective buyer).

With the rise of commerce on the Internet, most of the sales and marketing models used historically in the physical world marketplace have found a corresponding market on the Internet.

The bulletin board format of Craigslist.com, for example, is an example of a many-to-many marketplace for one-to-one transactions. Sellers list a description of an item, which is presented among a list of other items in a similar category or with matching keywords. Potential buyers can come to the website, search on the terms of interest to them, and find corresponding items. If something is of interest to the buyer, an arrangement for buyer and seller to meet and exchange payment for goods is confirmed.

There are also online stores, such as Amazon.com, in which buyers can search online among many products offered and, when they find a product they want offered at a price they are willing to pay, they can click on an online representation of a “button” to make a purchase. Payments are typically handled by credit card or an online payment system, such as PayPal, and goods are sent to the buyer by a conventional shipping service. These online shopping websites are typically a one-to-one shopping experience—the buyer must visit the online stores of several competitors to find out the options for pricing that various competitors offer.

The Amazon.com website may also serve as a platform for other companies to offer goods for sale, simplifying the competitive process. This “Amazon Marketplace” displays the various sellers names and may even display the offers by competing sellers for same product, allowing the buyer to choose between them while shopping at one website. The user may click on various “buttons” to learn more about the sellers, allowing them to select a product not only on price, but also considering the seller's ratings, location, shipping time, etc. Although this is a many-to-one shopping option, (many sellers offering their products to one buyer), and these various companies may be separate entities, Amazon often manages the order and shipping process for these sellers, making the appearance to the buyer simply that of an expanded inventory for a one-to-one buying experience with Amazon.com.

Websites for online auctions, such as Ebay.com, also exist. Here, sellers can offer an item for sale, and buyers bid on the item. At a pre-determined time, the auction closes, and one of the buyers is designated to be the “winner” of the auction. Payments are typically handled by credit card or an online payment system, such as PayPal, and goods are sent to the buyer by a conventional shipping service. Although this may appear similar to a many-to-many marketplace, each transaction takes place as a one-to-many (one seller to many buyers) auction.

However, unlike the other forms of marketplace, websites that mirror the consumer cooperative marketplace model are not widely established.

There are certain websites, such as Priceline.com, in which a buyer may make a statement of interest in buying an item at a certain price, and in which sellers then compete to provide the business in a process known as a reverse auction. This is truly a case of a many-to-one (many sellers competing for one buyer) transaction. However, such reverse auction websites are most commonly for the sale of a service that has an expiration date (for example, a hotel room or airline ticket on a certain date) and for which the value goes to $0 if the seller does not sell it. They are generally not used to buy a tangible physical object, such as a car or a bicycle, which does not degrade with time, and they are certainly not a means for multiple online buyers to pool their resources to create a bulk order for a seller.

Creating a group order for bulk purchasing can be done offline for an online purchase, with one buyer making the online purchase. Individual sellers may offer discount pricing for larger quantities of items (for example, having a lower unit price if buying more than 100 items), the transaction is between one individual online user, who buys more than 100 items, and one online seller, making these arrangements worthwhile.

Sellers may often get a benefit from a bulk discount. By sending larger quantities in one shipment, shipping costs can be saved and passed on the customer. By moving larger volumes of a product, sellers may in turn be able to get a better price for those items from their supplier. Also, if selling in volume directly to the customer instead of a distributor, the seller may be able charge a higher price to the end user than they might have received from a distributor, while offering a lower price than the buyer might receive from that same distributor. Internet shopping has been notorious for disrupting traditional supply chains, allowing buyers to buy directly from producers, cutting out the middlemen.

Yet, until this time, there are no known systems that can easily pool large numbers of online users and coordinate them into a group to make a bulk purchase of a product. There is therefore a need for an online system that can allow a buyer to enter an intention to purchase a product or service at a given price, as in a reverse auction, and then combine those intentions into a pooled, cooperative purchase order that sellers can then fulfill.

### BRIEF SUMMARY OF THE INVENTION

The invention disclosed with this application is a system for managing online commerce, and in particular, provides a system that analyzes representations of “Intentions” that a Buyer enters into the system and items identified as being available in a Sellers Inventory Database. In some embodiments, the Buyers' Intentions are pooled or grouped into a “Groupbuy” that a Seller can fulfill with a single shipment.

In some embodiments, the system employs matching algorithms to match individual Buyers (or pooled Buyers in a Groupbuy) with Sellers.

In some embodiments, an individual Buyer may initiate a Groupbuy, and other Buyers may join the Groupbuy without the execution of any matching algorithms.

In some embodiments, the system additionally manages payment transactions, and provides vouchers to the Buyers to certify they have paid and may take delivery of the purchased product.

In some embodiments, the system is implemented on a central server that manages the matching and financial transactions, and in which Buyers and Sellers both may access portions of the data on the central server through the Internet using conventional web browsers implementing standard Internet protocols.

### BRIEF DESCRIPTION OF THE DRAWINGS

FIG. 1 illustrates a schematic block diagram of servers and local computers as may be used to implement software embodiments of the invention.

FIG. 2 illustrates a schematic block diagram of the databases for an embodiment of the invention.

FIG. 3 illustrates a flow chart for the initial steps taken in a first embodiment of the invention.

FIG. 4 illustrates a screen snapshot of a typical shopping screen according to an embodiment of the invention.

FIG. 5 illustrates a screen snapshot of a typical search result display screen according to an embodiment of the invention.

FIG. 6 illustrates a flow chart for the second set of steps taken in a first embodiment of the invention.

FIG. 7 illustrates a screen snapshot showing one item selected from a list of items found in a search according to an embodiment of the invention.

FIG. 8 illustrates a screen snapshot showing an example of the records comprised in an Intention according to an embodiment of the invention.

FIG. 9 illustrates a flow chart for the third set of steps taken in a first embodiment of the invention.

FIG. 10 illustrates a flow chart for the fourth set of steps taken in a first embodiment of the invention.

FIG. 11 illustrates a flow chart for the fifth set of steps taken in a first embodiment of the invention.

FIG. 12 illustrates an embodiment of the invention in which an Intention is entered as text.

FIG. 13 illustrates a block diagram of a computer system as may be used in various embodiments of the invention.

### DETAILED DESCRIPTIONS OF EMBODIMENTS OF THE INVENTION

### I. Introduction

Systems according to the embodiments of the invention presented herein are typically are implemented by means of software compiled to run on at least one and typically more than one computer systems. The access to computer systems (or servers) running some or all of the software may be locally managed, or may be provided by a connection through the Internet, with various remote computers connecting to the servers using protocols such as a data channel using protocols such as Hypertext Transfer Protocol (HTTP) and Transmission Control Protocol/Internet Protocol (TCP/IP), for example. The systems according to the invention may have only a limited number of operations running on the remote computers (e.g. local operations may only comprise code to manage the local display a webpage in a browser, and to provide connectivity) written in standard languages for supported by web browsers, such as HyperText Markup Language (HTML) for example, or may share a greater portion of the computations that must be executed with the local computer.

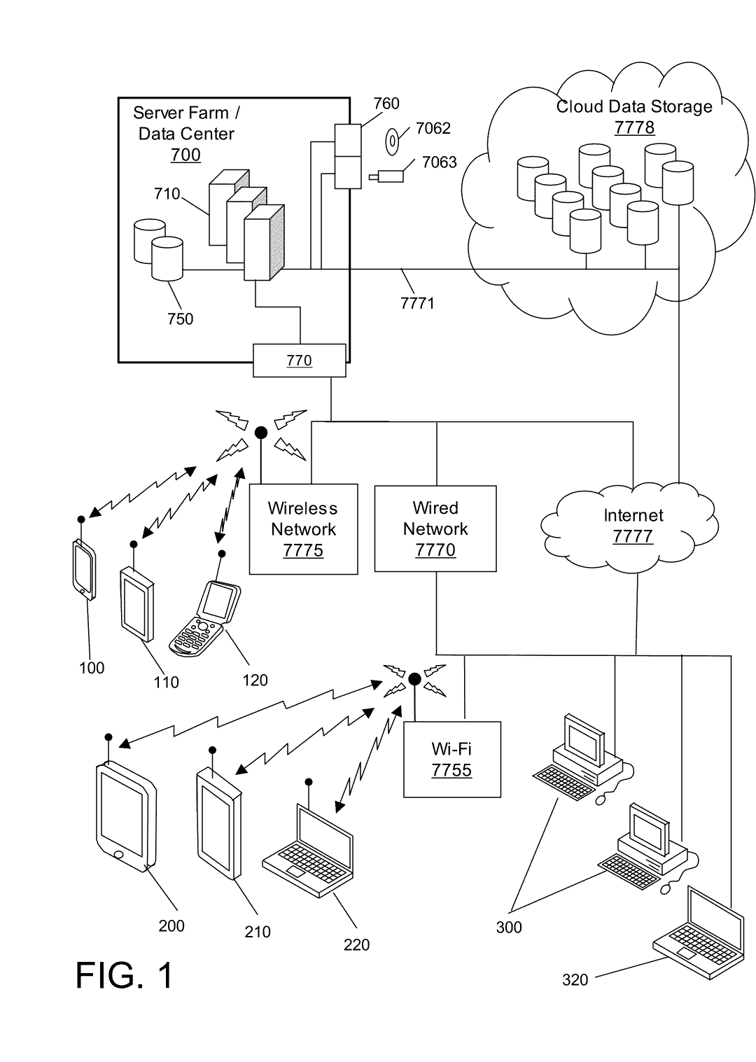

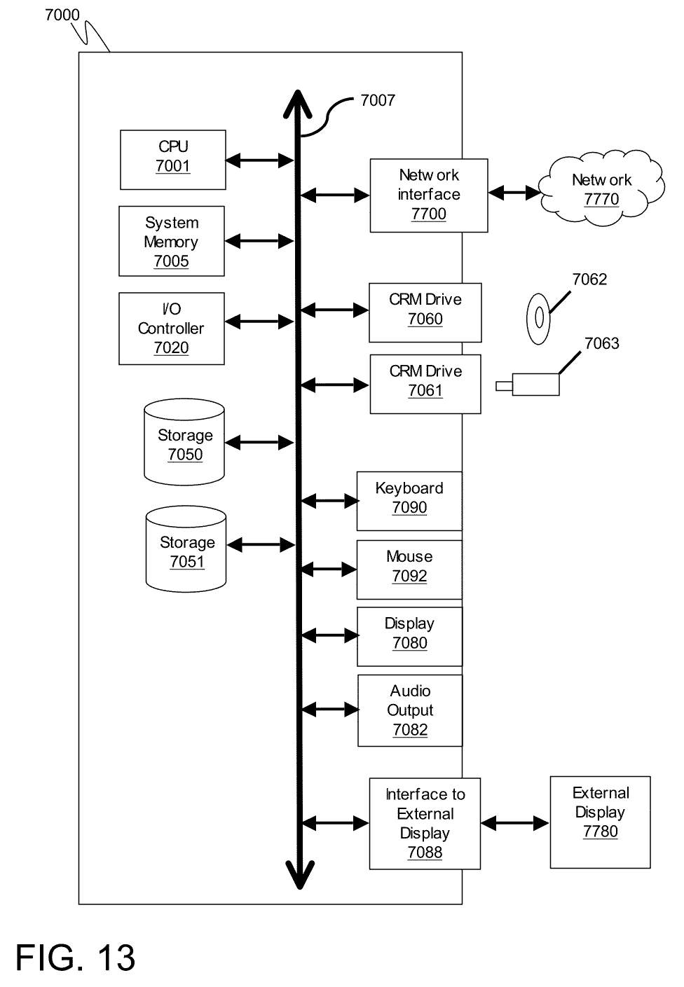

A representative configuration for a set of computer systems upon which the methods of the invention may be implemented and accessed through the Internet is illustrated in FIG. 1. In this illustration, the software code providing instructions to execute the method of the invention are loaded and executed using a central computer system 700, which may comprise a server farm with one or more server computers 710. These computers 710 may be similar to the computers described in more detail below in section V and illustrated in FIG. 13, or may be one of many variations known to those skilled in the art.

Connected to the computers 710 within the central computer system 700 may also be one or more local storage devices 750, such as magnetic disk drives, that may comprise non-transient computer readable media upon which are stored the instructions that, when executed by the computer system, may cause the methods of the invention to be executed. In addition to the local storage devices 750, the computer system 700 may also comprise ports 760 to allow portable non-transient computer readable media, such as CD-ROMs 7062 or USB Thumbdrives 7063 to be connected.

As illustrated in FIG. 1, the server computers 710 of the computer system 700 may also be connected to an external data storage, such as a cloud storage facility 7778, either with a direct wired connection 7771 or through the Internet 7777. In some embodiments, the data about Buyers, Intentions, Sellers, and Inventory may reside in the cloud storage facility 7778, while the computer program code that allows the methods of the invention to be executed may reside on non-transient storage media 750 within the computer system 700. In some embodiments, the computer program code that allows the methods of the invention to be executed may also reside on non-transient storage media housed in the cloud storage facility 7778.

As illustrated in FIG. 1, the server computers 710 of the computer system 700 may also have a network interface 770 that allows it to be connected to various networks 7777, 7775, 7770 that allow Buyers and Sellers to access the system from remote computers and other data processing devices.

One possible network is the Internet 7777, which remote computers 300, 310 may access through any number of methods that will be known to those skilled in the art. Another possible network is a wired network 7770, such as a telephone network, which may provide a direct connection between the server computers 710 and the remote computers 300, 320 or with local wireless networks 7755 such as those enabled with Wi-Fi (such as the IEEE 802.11 family of standards, or other wireless communication technologies, such as Bluetooth wireless personal area network, or any combination thereof) to provide a connection between the system computer 700 and various tablet computers, such as an iPad® 200 manufactured by Apple Inc. of Cupertino, Calif., Kindle® devices 210 sold by Amazon.com of Seattle, Wash., or other computers, such as laptops 220 equipped with RF transceivers for connection to these local wireless networks 7755.

Another possible network is a wide area wireless network 7775, such as a 3G or 4G cellular phone network, which may provide a direct connection between the server computers 710 and various models of cellular phones 120, or “smartphone” personal data processing devices, such as an iPhone® 100 manufactured by Apple Inc. of Cupertino, Calif., or wireless phones 110 enabled with the Android® operating system developed by Google Inc. of Mountain View, Calif.

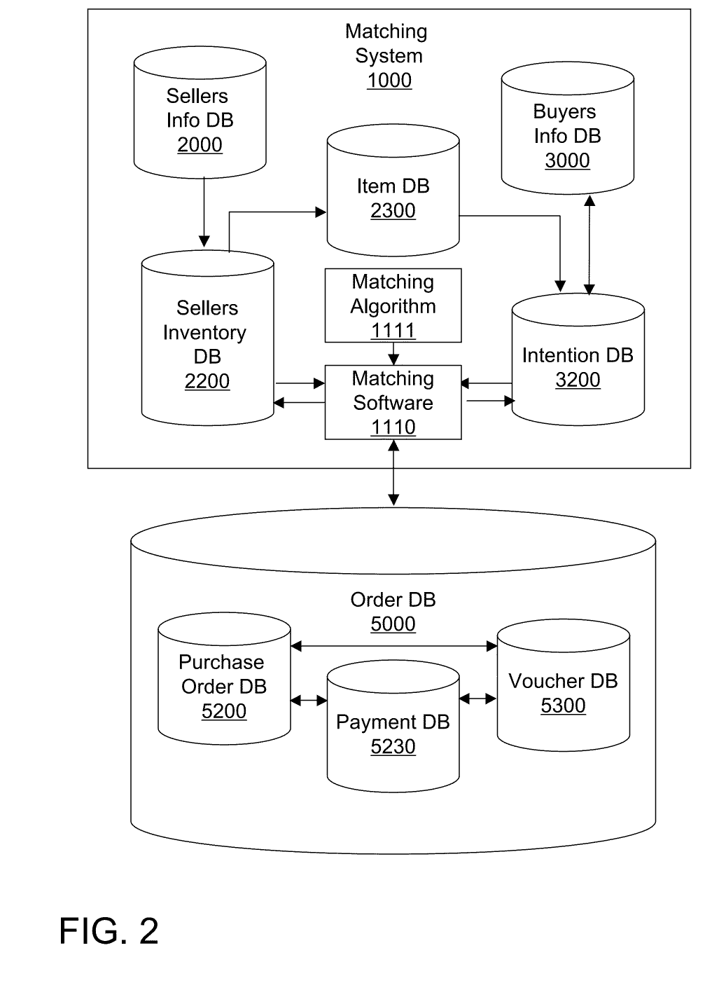

The system according to some embodiments of the invention presented herein may comprise a number of interconnected databases, as illustrated in FIG. 2. These databases may be implemented as a single master schema in a single software system on a single storage system, such as the storage unit 750 illustrated in FIG. 1, and may be executed in software running on a single server computer, or may be stored as several distinct databases on several different storage systems, such as the cloud data storage system 7778 illustrated in FIG. 1. Different computers may be designated to run different portions of the software that connect the databases.

FIG. 2 illustrates the various databases that are connected in one embodiment of the invention. In some embodiments, the databases used by the system will be encoded electronically on non-transitory computer readable media, such as disk drives. The system comprises a Sellers Information Database 2000, which will typically comprise information about the Sellers who have registered to sell items through the system, and may include such entries as the Seller's name, address, and the sales transactions they have conducted using the system. The system also comprises a Sellers Inventory Database 2200, which comprises information about the items that a given seller has available for sale. The system also comprises an Item Database 3200, which comprises a listing of items that a buyer can browse and select to purchase, and which may comprise the item name, model number or numbers, description of properties and features, photos of the item, etc.

These databases may have entries that duplicate content. For example, in some embodiments, the Sellers Information Database 2000 may be constructed with a schema that also includes the Sellers Inventory, making a separate Sellers Inventory Database unnecessary. Likewise, the Item Database 2300 may simply be a superset of all the items offered by all Sellers found in the Sellers Inventory Database 2200. However, in some embodiments, the Item Database 2300 may comprise all items ever sold through the system, without regard to whether a registered Seller is currently offering a particular item for sale. In other embodiments, the Item Database 2300 may also comprise items that a Buyer has identified as desirable and has inserted into the Item Database 2300, even if no current Seller is offering that particular item.

The system also comprises a Buyers Information Database 3000, which will typically comprise information about the Buyers who have registered to buy items through the system, and may include profile information such as the Buyer's name, address, credit card or other payment information, and the sales transactions they have conducted using the system. Information about forecasts or predictions for a Buyer's possible interests and future purchases may also be included.

The system also comprises an Intention Database 3200, which comprises information about items that a given buyer has identified as being desirable.

These databases may have entries that duplicate content. For example, in some embodiments, the Buyer's Information Database 3000 may be constructed with a schema that also includes the Buyer's Intentions.

Once a buyer has created an Intention listed in the Intention Database 3200, the matching software 1110 using various matching algorithms 1111 of the system 1000 operate on the various Intentions in the Intention Database 3200 to pool individual intentions into a “Groupbuy”, as will be described in more detail below. The algorithms 1111 will also match entries in the Intention Database 3200 to entries in the Sellers Inventory Database 2200, and create a Match when buyers and sellers have agreeable parameters. When a Match is found, an Order is created in the Order Database 5000.

The Order Database in the embodiment of FIG. 2 comprises three main components: an Purchase Order Database 5220 that comprises a list of matches between one or more Buyers and one or more Sellers; a Payment Database 5230 that comprises a record of which Buyers have paid for their Purchase Orders; and a Voucher Database 5300 which comprises Vouchers generated once a Buyer has paid, and that can be provided by the Buyer to the Seller or its agent to receive the item purchased. Once the Seller receives the Voucher (which nominally confirms that delivery of the item has taken place) the Voucher can be presented to the Order Database 5000, which allows funds to be released to the Seller.

### II. A First Embodiment of the Invention

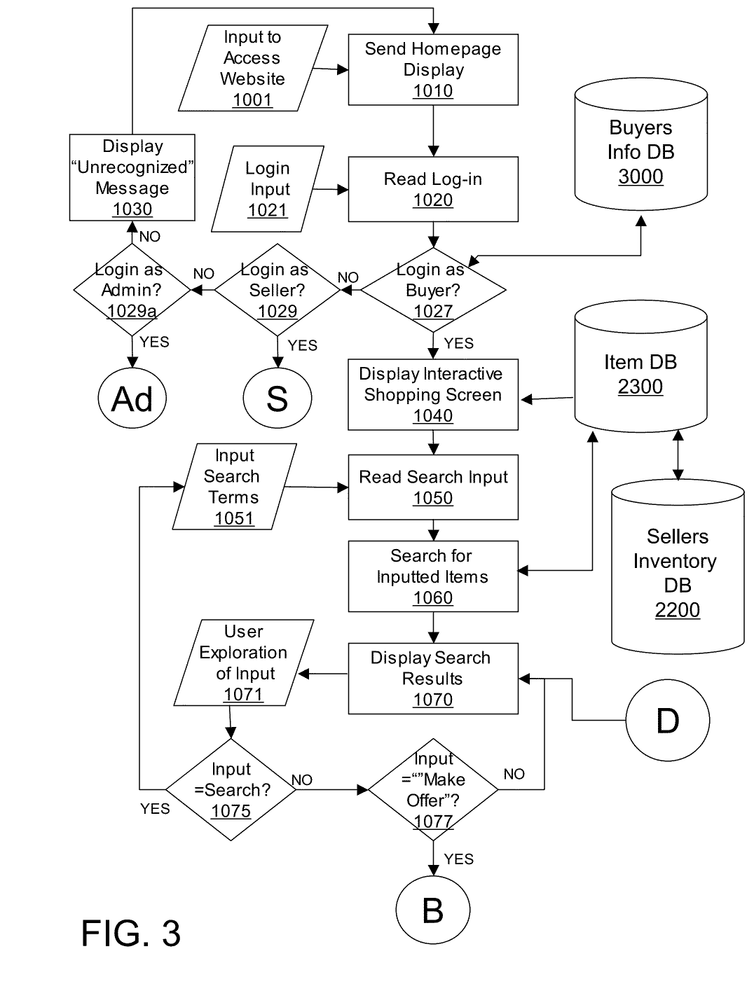

One embodiment of the invention is illustrated in FIGS. 3 through 11. Turning now to FIG. 3, the initial steps executed by the System 1000 are illustrated. In most embodiments, the system will be designed to be accessed through the Internet by means of a web browser, and can be accessed by a computer, a tablet, a smartphone, a Smart TV, or any other device with Internet access. To start, the Buyer (at this point, more accurately called a User, since an intention to buy has not yet been entered) initially launches a software tool to access the Internet, such as a web browser, entering various input commands or keystrokes (representing, for example, a web address) to access the website 1001 corresponding to the software. The system responds by proceeding to the next step 1010 that sends signals representing the display to show on the User's screen that access to the system has been achieved, for example, a Homepage display.

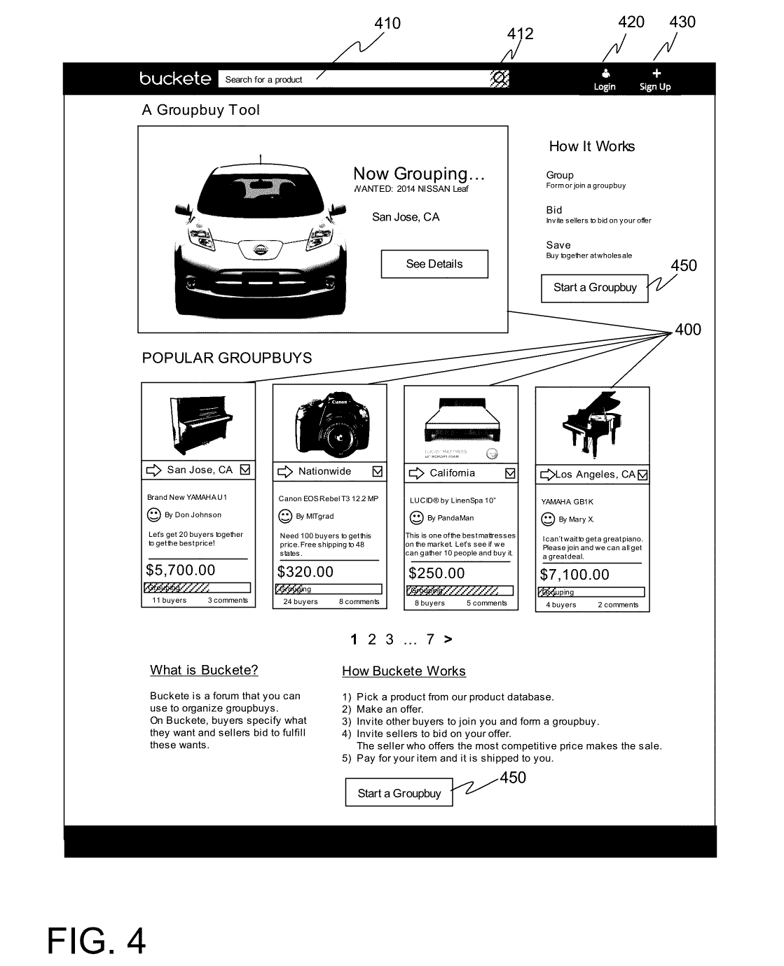

An example of a Homepage according to one embodiment of the invention is illustrated in FIG. 4. In this illustration, the Homepage displays various opportunities for Buyers 400, as well as providing certain fields for data input, such as a “search” bar 410 with an attached search button 412 to execute a search, a “Login” button 420 for registered users, and a “Sign Up” button 430 for new, unregistered users. Buttons labeled “Start a Groupbuy” 450 are also provided.

In some embodiments, if the User attempts to do anything on the displayed Homepage, the system will respond by providing a display in which a user can enter Login information. Returning to FIG. 3, when the Buyer provides Login Input 1021, in the next step 1020, the system reads the login information, and then proceeds with a checking step 1027 to determine whether this input information corresponds to a Buyer in the Buyers Information Database 3000.

If the Login information does not correspond to a Buyer in the Buyers Information Database 3000, the system will proceed to a step 1029 to determine if the login corresponds to a Seller in the Sellers Information Database 2000. If so, the program transfers to the steps marked with the letter “S”, wherein the user will be directed to a Seller's Dashboard page, where seller can review and manage statements of inventory, respond to orders, and the like. Note: details of the Seller's Dashboard are not further disclosed in this Application.

If the Login information does not correspond to a Buyer or Seller the system will proceed to a step 1029a to determine if the login corresponds to a System Administrator. If so, the program transfers to the steps marked with the letters “Ad”, wherein the user will be directed to an Administrator's interface page. From here, a system Administrator can edit elements of an Intention, change the weighting functions used in certain matching situations, and other supervisory functions. Note: details of the Administrator's interface, other than as various options for embodiments of the invention, are not further disclosed in this Application.

If the input is neither a Buyer nor a Seller nor an Administrator, the program proceeds to a step 1030 that displays that the input is “unrecognized”, and then returns the control to the initial step 1010 that displays the Homepage.

If the Login information does correspond to a Buyer in the Buyers Information Database 3000, the system logs the time of arrival into the Buyers Information Database 3000 and then proceeds to the next step 1040 that displays an interactive Shopping Screen. The shopping screen may be laid out to show various images and brief descriptions of items listed in the Item Database 2300 in an array format, with the Buyer presented with virtual buttons to “click” by using a mouse corresponding to a cursor displayed on the display screen, or other data input tool such as a finger touching a touchscreen on a smartphone to designate the virtual “pressing” of the button.

In some embodiments, this shopping screen may also have a “search” input field, as was illustrated in FIG. 4, that will allow the Buyer to type an alphanumeric string, such as “camera”, followed by an enter key, or followed by pressing a “search” icon. Returning to FIG. 3, this data entry corresponds to the step labeled Input Search Terms 1051.

Once the input 1051 for the search terms has been provided, the program will execute a step 1050 that interprets the input 1051 and proceed to the next step 1060, launching a search of the Item Database 2300 for items that match the search term or terms. This search function may actually be a multi-dimensional search, as described in more detail later, if the Buyer's input is incomplete or ambiguous.

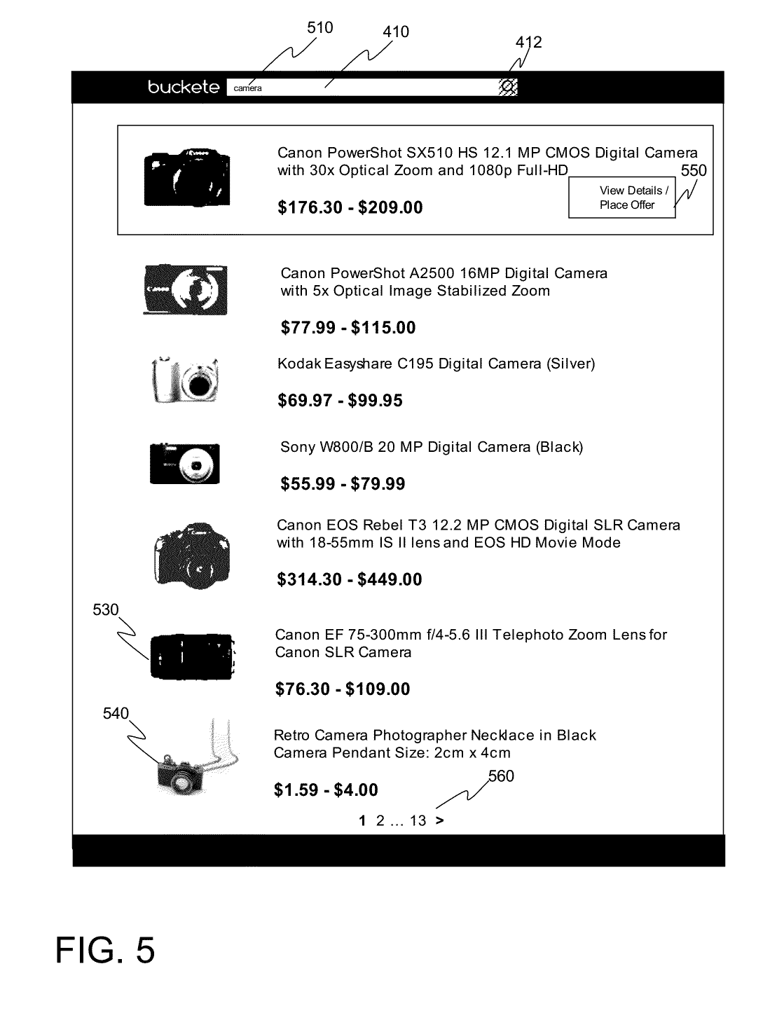

After searching, the system will display the results of the search in the next step 1070, (which may, for example, be various cameras if the search term was “camera”). Illustrated in FIG. 5 is an example representing possible search results when the term “camera” 510 is entered in the search bar 410 and the search icon 412 invoked. In this illustration, several items that match the search term “camera” are illustrated, arranged vertically, with an image of the item on the left and a description and tentative price range on the right. The items may be arranged in one of many different orders, such as by price, by most frequently bought, by brand name, in alphabetical order, or by one of many options known to those skilled in the art. In some embodiments, the ability to toggle between these listing options may be made available with an onscreen button or pull-down list and selected by the user. The prices displayed may also be produced in a number of ways, and in some embodiments will be a listing of prices paid by Buyers in the past, in others a listing of retail prices available from other sources, or in others may be a price range calculated by some other algorithm.

Note that, in this illustration, several of the items matching the search term “camera” are actually cameras of various types. However, one item 530 is a camera lens, not a camera. Another item 540 is a piece of jewelry that is shaped like a camera, and not a camera itself at all. Both, however, match the word “camera” in their description. As with any search engine, the thoughtful use of search terms will provide better matching of items found to the items sought. The search engine invoked with the embodiments of the invention may be a conventional commercial search engine, such as those provided by Google Inc. of Mountain View, Calif., or by other commercial suppliers of search engine software, or may be another customized search function designed for implementation with the specific databases of the disclosed system.

The Buyer will typically be provided with an option that allows the selection of one of the various items corresponding to the search results (such as clicking on photos or descriptions of various items matching “camera”) to explore them further. In the example of FIG. 5, the top entry is highlighted and this highlighting invokes the display of a button labeled “View Details/Place Offer” 550. In a typical embodiment, as the user moves a cursor through the display, the appearance of such buttons that allow the display of more detail or information may appear and disappear. In some embodiments, multiple pages of search results may be available, and a page counter/selection graphic 560 may be provided to allow the user to look at different pages of listings.

Returning to FIG. 3, with each input 1071, the system will check 1075 whether one of the user inputs is an additional entry in the “Search” field 410 or the search button 412. If the result is positive, the program returns to the Search step 1050, accepting the new input 1051 to the search field. If the input does not correspond to a Search, however, the system will then check 1077 whether one of the user inputs is a selection of one of the “View Details/Place Offer” buttons 550 corresponding to one of the items. If it is not (for example, if it is a click on the page selector 560), the system simply passes on the instructions as determined by the coding for the Display Search Results step 1070 (e.g. showing “more information”, such as displaying the next page of search results).

However, if the input corresponds to a “View Details/Place Offer” button 550 on the screen, the system passes control to the next step, which creates an Order, represented by the “B” in FIG. 3.

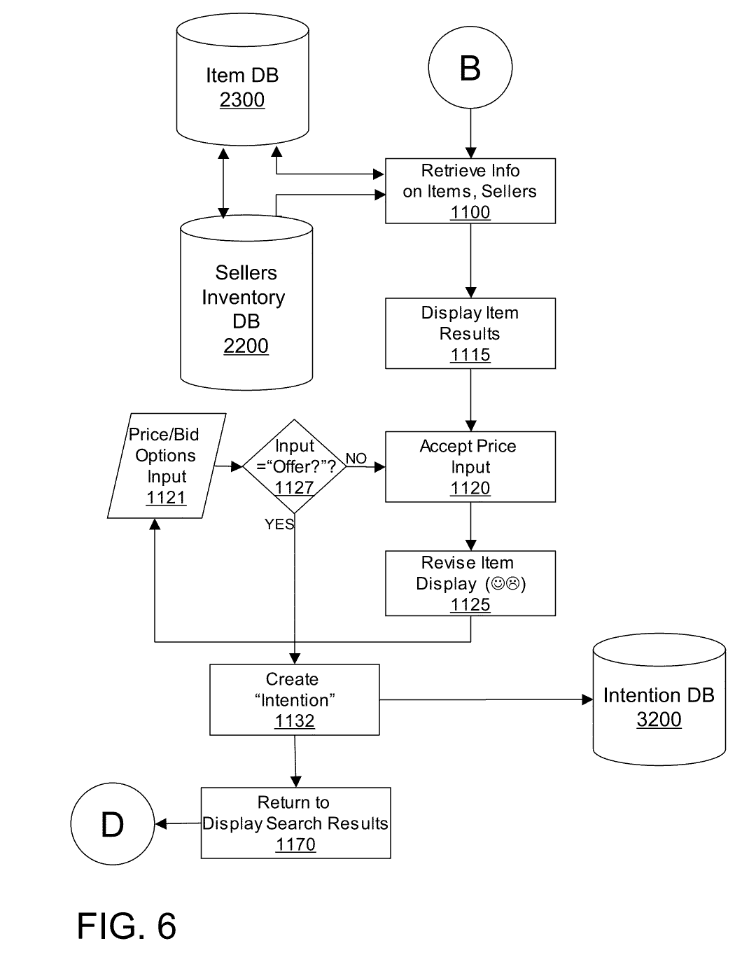

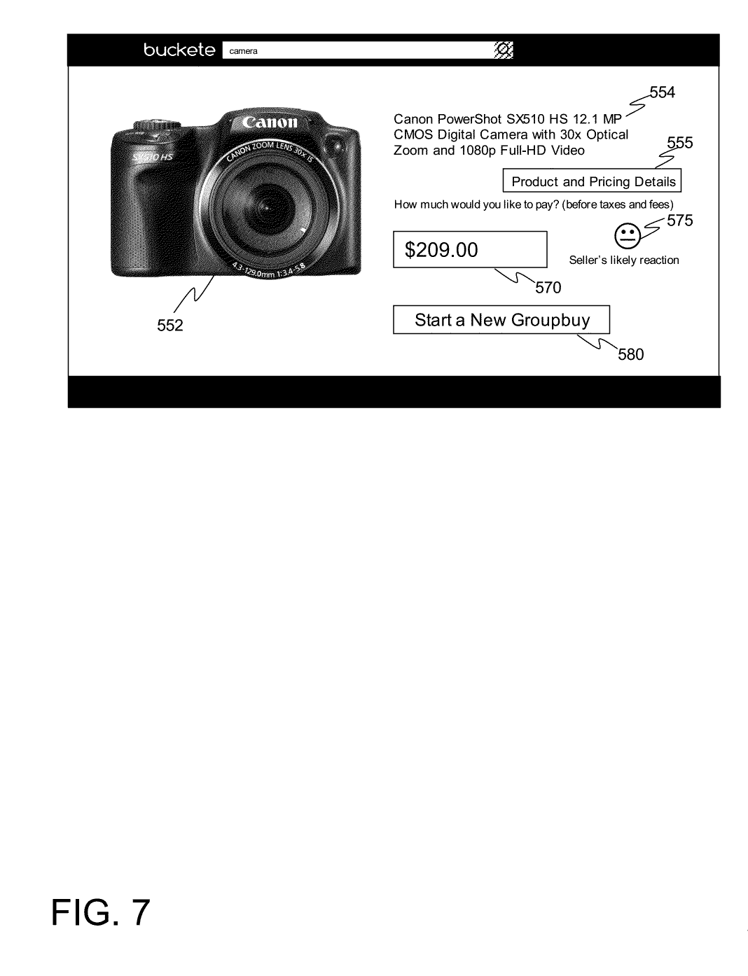

Moving now to FIG. 6, after the steps in FIG. 3 have passed control to the ordering system, represented by “B”, in the next step 1100 the system retrieves information on the item selected for ordering from the Item Database 2300 and also the Sellers Inventory Database 2200. The available items are then displayed in the next step 1115. A possible representation of a display at this point is illustrated in FIG. 7.

In a typical product information display, as illustrated in FIG. 7, there may be an illustration 552 which may be a photograph, drawing, or representative icon corresponding to the item, a brief text description 554, a button to link to a more detailed description 555, and various action buttons 570, 580.

There can be some variation in the programming of this display. For example, in some embodiments, if Sellers offer a product but have none currently in inventory, the illustration 552 may show a representation of the item in grey, indicating the Sellers are currently out of stock. Or, in some embodiments, this may explicitly display that the item is out of stock, but that pre-orders are still allowed for the time the item is again in stock. Or, in some embodiments, the images and information corresponding to the item itself may simply be displayed, with no information on immediate availability.

One action button for user input 570 allows the user to enter a proposed price as a bid for the item. Returning to FIG. 6, the Buyer's next step 1121 is to input a price in this field, typically a numerical representation in dollars and cents.

With each input 1121 of price, in some embodiments the system will check 1127 whether one of the inputs also comprises a click on the “Make a Groupbuy” key. If it is not, the system simply passes on the instructions as determined by the coding for the “Accept Price Input” step 1120 and revises the item display, based on the information imported from the Item Database 2300 and the Sellers Database 2200. This change in display 1125 may be, for example, the change of an icon representing a seller's response 575, as illustrated in FIG. 7, from a smile face to a frown when the price entered as a bid entered is determined by an algorithm in the system to be significantly lower than a bid most sellers will accept. Likewise, if the input is at a price far higher than the list price of the item, the smile face may change to a happy face. More details on these algorithms for display modification are presented later in this Application.

If the input click is a “Start a New Groupbuy” button, the checking step 1127 passes control to the next step 1132 that creates a data structure corresponding to an “Intention”, linking the Buyer's information, the Item information, and the bid into a non-transient entry into the Intention Database 3200. Once an Intention or Groupbuy has been created, the system may take the next step 1170 of returning to the “Display Search Results” screen 1070, represented by the “D” in both FIGS. 3 and 6.

The record for an Intention in the Intention Database 3200 typically comprises non-transient data representing: a unique identifier for the Intention or Groupbuy, an identifier of the item to be bought, Buyer information, the desired condition and quantity, the maximum price that buyer will pay, shipping destination information (e.g. city and state) and the ending date before which the Buyer(s) want to receive the product. Data representing various parameters, such as the total number of Buyers desired to fulfill the Groupbuy, or a length of time after which an Intention will be deemed unfulfilled and closed if that number of Buyers do not join, and the like may also be stored.

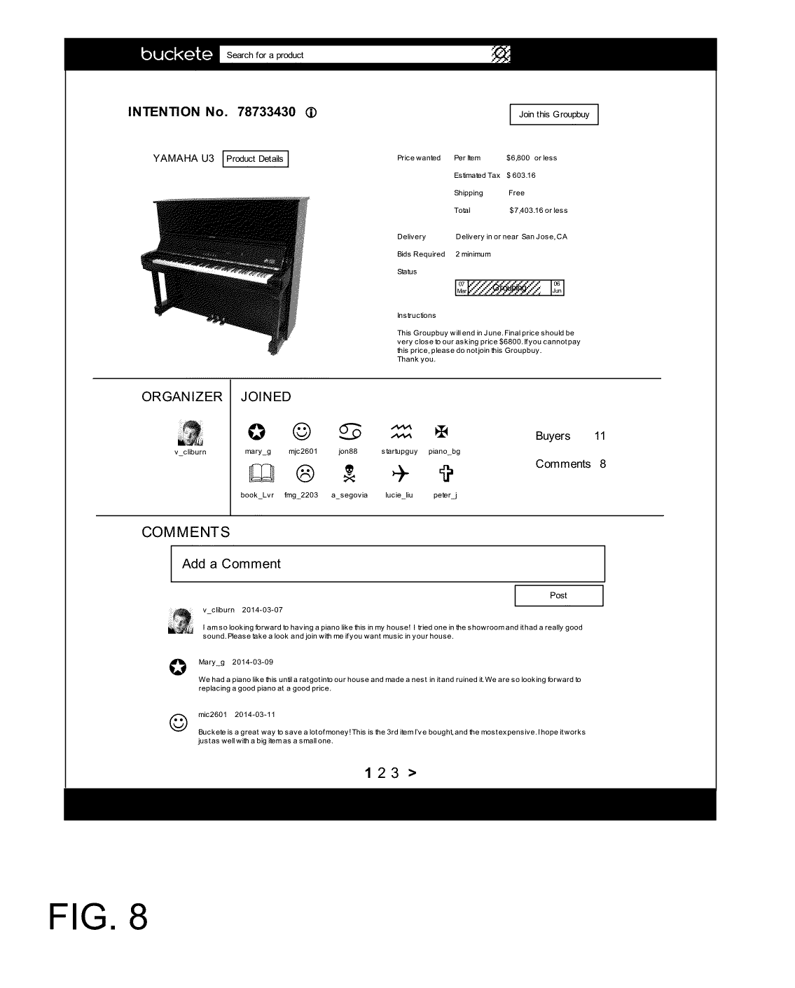

A representation of a display corresponding to an Intention is illustrated in FIG. 8. In this illustration, for the intention to purchase a piano at $6,800, there is a section with information about the product and the status of the Groupbuy, a section about the Buyers, and a section in which comments can be added. More detail about these “social shopping” aspects of embodiments of the invention will be disclosed in a later section.

Additional fields in the data structure representing the Intention in the database may represent additional information about the status of a prepaid refundable deposit, record proof of payment in full or in part for each of the Buyers, item shipment status, billing address and shipping address, and the like.

With the creation of the data structure corresponding to an “Intention” representing the commitment of the Buyer to purchasing the item at the bid price, the program ends and the creation of the data structure is completed. This is publicly visible through the Internet as an Intention details page, such as the one illustrated in FIG. 8, displaying the details of the created Intention, so that the other buyers can view and create a similar Intention or join the existing Intention. The Intention is now waiting in the system for subsequent matching steps to occur, or for other Buyers to voluntarily join to transform the Intention of a single person into a Groupbuy.

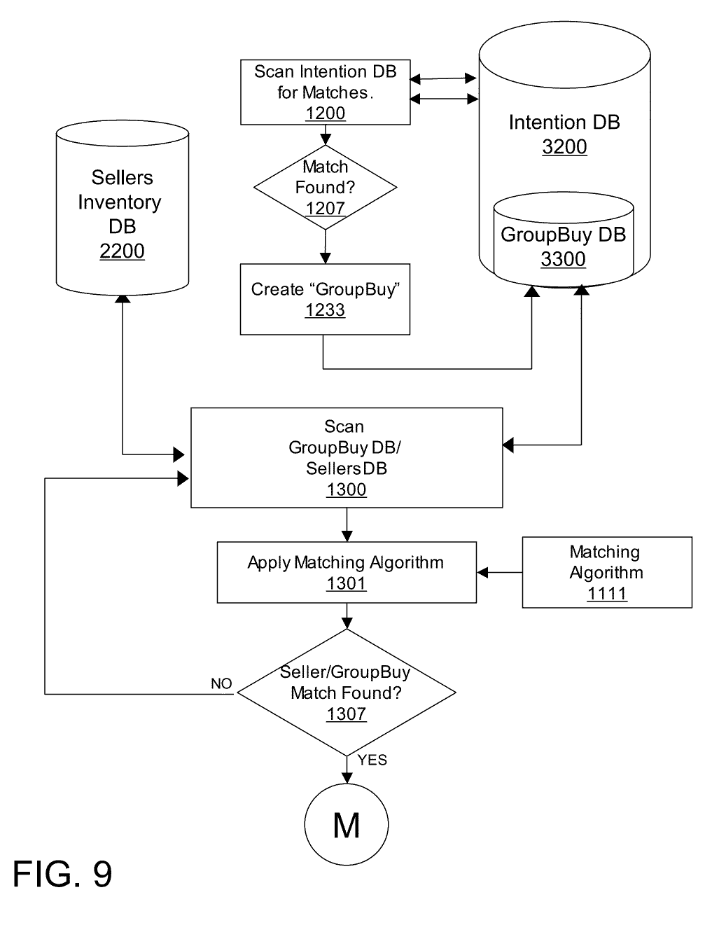

Meanwhile, as illustrated in FIG. 9, the system 1000 will be concurrently executing a step 1200, either continuously or, in some embodiments, intermittently at pre-determined intervals, in which the system scans the Intentions in the Intention Database 3200 looking for common items and matching bids. If a comparison step 1207 identifies that more than one Intention have a match (for example, both requesting the same model of bicycle), then in the next step 1233 the matched Intentions are pooled into a “Groupbuy”, stored in a Groupbuy Database 3300 as a subset of the Intention Database 3200.

There are several possible configurations for the formation of a Groupbuy. In some embodiments, the “Groupbuy” may simply be the addition of an extra field in the Intention database, expressing a relationship between a given Intention and the other Intentions in the Groupbuy. In other embodiments, the creation of a Groupbuy may remove the original matched Intentions from the Intention Database 3200, replacing them with the pooled entry in the Groupbuy Database 3300. In one embodiment, the Intentions are only linked in that they have same maximum price Buyers are willing to pay, with other details, such as condition (e.g. new or used) and fulfillment time nearly or exactly the same. Other configurations to manage the Groupbuy scheme will be known to those skilled in the art.

As the system scans the Intention Database 3200 to create Groupbuys, it also executes a step 1300, either continuously or intermittently, that scans the Groupbuy Database 3300 along with the Sellers Inventory Database 2200 and executes a step 1301 that applies a matching algorithm 1111 to look for a match between Groupbuys and Sellers.

The matching also includes a comparison step 1307. If no match is found, the system continues its search. However, if a match is found, the system passes control to the next step, which creates an Order, represented by the step marked M in FIG. 9.

In some embodiments, the matching algorithm may comprise calculations of quantities or weighting factors that take a series of parameters into consideration in determining a match, including feedback scores for the Sellers, feedback scores for the Buyers, the bidding price, the physical address or general location for the respective Buyers and Sellers, and the like.

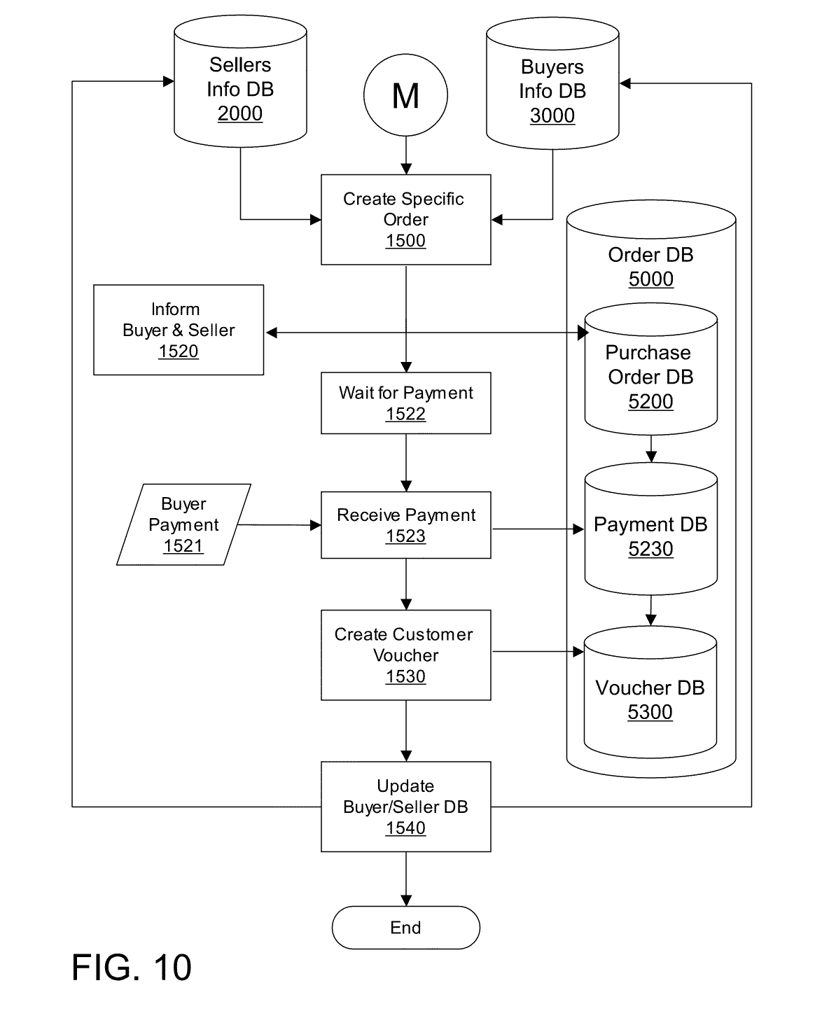

Moving now to FIG. 10, which proceeds from the step in FIG. 9 marked M, in the next step 1500 the system retrieves information on specific Sellers and Buyers from the Sellers Database 2000 and the Buyers Database 3000 to create an Order. This Order will be inserted into the Purchase Order Database 5200, which is a subset of the overall Order Database 5000. At this point, the next step 1520 will be a notification to both Buyer and Seller that a match has been found and a purchase relationship established.

Depending on the nature of the agreements when a Buyer and Seller sign up to participate in the system, this relationship may be one of several possible relationships. It may simply be one of being informed parties, with the system acting as “matchmaker”. In other embodiments, it may be a contractual agreement, committing the Buyer to buy and the Seller to sell if a match is found. Such a contract may be a legally binding agreement if certain predetermined terms have been agreed to by Buyers and/or Sellers at an earlier date, such as upon “clicking” an approval for an end-user agreement while registering for to use the system. Other possible relationships will be known to those skilled in the art.

The system as configured in this embodiment will be continually accepting input from a multiplicity of buyers, accepting their Intentions into the Intention Database 3200, grouping their Intentions into Groupbuys in the Groupbuy Database 3300, and scanning the Groupbuys and the Sellers Inventory Database 2200 for matches and generating Purchase Orders that are inserted into the Order Database 5000.

Once a Purchase Order has been created and the Sellers and Buyers informed, by means, for example, of an electronic communication such as e-mail, as far as that transaction is concerned, the system has little more to do, so its next step (with regard to this transaction) is waiting 1522. The next step is at the discretion of the Buyer, who must provide for payment 1521. In an embodiment where the Buyer Database 3000 comprises credit card and other payment information, payment may be an automatic step. In some embodiments, payment may be an automatic step executed at the time of the creation of the Intention. In some embodiments, payment may be an automatic step executed as soon as the Order has been generated. In embodiments in which the Buyers Information Database 3000 does not include payment information, the Buyer may need to log into the system, access the Order Database 5000 and authorize a payment manually. Payment terms may vary, depending on the transaction. For example, for small or inexpensive items, payment in full may be required in advance, while for more expensive items, payment of only a certain percentage or deposit (e.g. 10% of the full price) may be required in advance.

In the next step 1523, the system receives confirmation of the payment, and logs the information into the Payment Database 5230, which, in this embodiment, is a subset of the Order Database 5000. Once acknowledgement of payment is received, the system will progress to the next step 1530, which comprises creating a Customer Voucher (which may be a simple but unique code number, or may be an image of a certificate, or some other presentation of information confirming the transaction) and storing it in a Voucher Database 5300, which in this embodiment is shown as a subset of the Order Database 5000. Once the Voucher for the Groupbuy has been created, both Sellers and Buyers will be informed that the Voucher exists, such as by e-mail or other electronic transmission, and the respective Seller Information Database 2000 and Buyer Information Database 3000 will be updated.

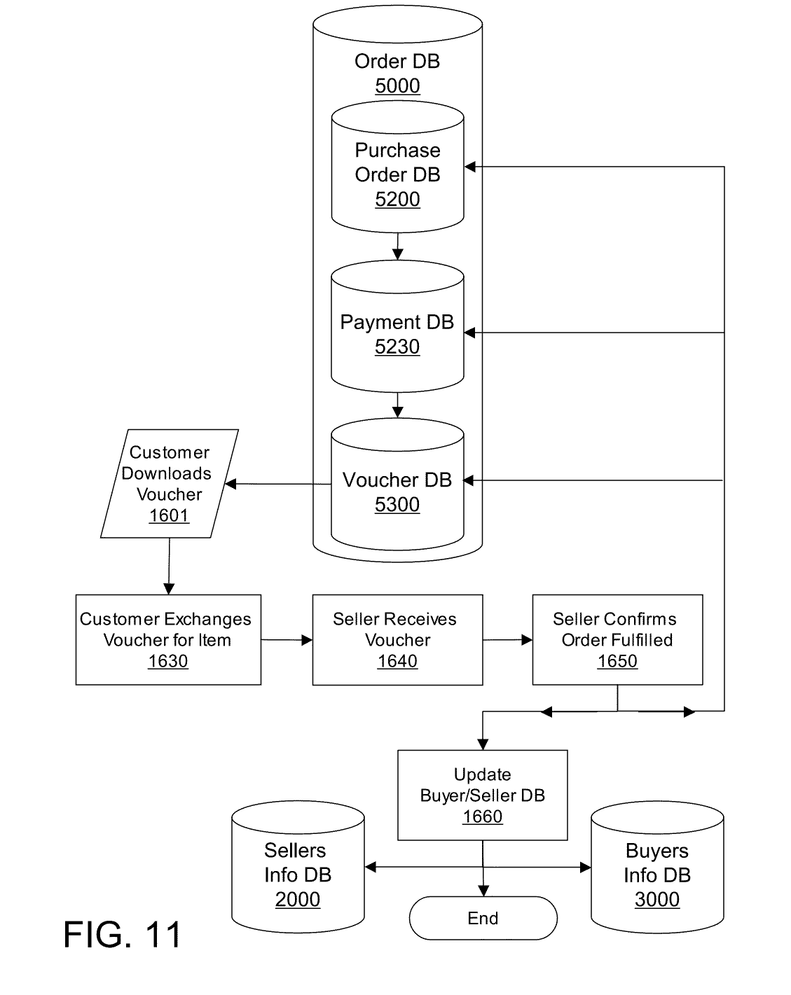

As illustrated in FIG. 11, it is then the responsibility of the Buyer to download the Voucher in the next step 1601 for presentation to the Seller in exchange for the Item in the next step 1630, and the Seller (or its representative) receive the Voucher (or the Voucher of partial payment and the balance of the payment owed) in the next step 1640, upon delivery of the Item to the pre-determined delivery location.

Once the Seller has delivered the Item and received Voucher information (or received a printout of the voucher, if a certificate format is used), in the next step 1650 the Seller can report to the system the conclusion of the transaction. The next step 1660 taken by the system is the update of the Seller and Buyer Databases with the information on the conclusion of the transaction.

After this, the transaction is complete.

### III. Variations on Embodiments of the Invention

### III.1. Reverse Matching

As described in the above embodiment, the matching algorithm can be a simple match for an Intention, either from a single buyer or from a pooled Groupbuy, with a particular Seller's inventory at a predetermined mutually agreeable price.

However, various matching algorithms may be implemented in various embodiments of the invention, especially between multiple Buyers and multiple Sellers.

One such embodiment is illustrated using Table A. In this table, hypothetical Intentions for one or more Canon PowerShot SX510 HS cameras (which has a nominal retail list price of $249.99) are listed. On the left side of the table are five (5) Intentions from Buyers (which may be individual buyers or pooled Groupbuys), and on the right side of the table are three (3) Offers from Seller's Inventory. Both are ranked from highest price to lowest price in the Table.

TABLE A
An example of five Intentions and three Seller's Offers for the
hypothetical purchase of a camera. The “List price” for a Canon
PowerShot SX510 HS is $249.99.
Canon PowerShot SX510 HS

| Buyer's Intentions (Groupbuys) | Seller's Offers |
|---|---|
| Intention 1: | Seller 1: |
| 1 @ $250 | Inventory: 280 |
| Intention 2: | Min. Price: $249 |
| 15 @ $225 | Seller 2: |
| Intention 3: | Inventory: 1852 |
| 4 @ $215 | Min. Price: $209 |
| Intention 4: | Seller 3: |
| 20 @ $199 | Inventory: 1515 |
| Intention 5: | Min. Price: $179 |
| 10 @ $179 | |

Assuming for the moment that, for this example, a Seller is prevented from offering a product at an actual loss, and therefore still makes a slight profit when selling at $179.00. In a one embodiment of a reverse matching algorithm, illustrated in Table A1, all Buyers are matched with the Seller with the lowest selling price (as opposed to a regular auction, which matches a seller to the buyer with the highest price).

TABLE A1
A first example of matching Intentions and Seller's Offers as presented in
Table A for the hypothetical sale of 50 cameras.

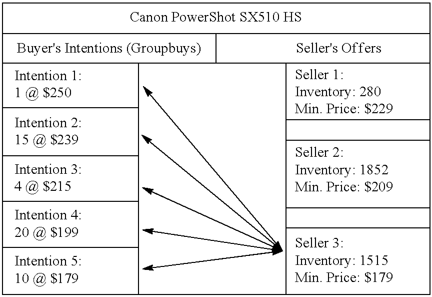

A comparison of the discounts and surpluses received when the price for the transaction is set at the average between the Buyer's Intention and Seller 3's offer of $179 is presented in Table B1. By setting the price at the average between the Buyer's bid and the Seller's asking price, for each camera sold the Seller and each Buyer will receive an equal benefit—the Seller as a surplus over their offer price, and the Buyer as a discount from their asking price. In this manner, the seller willing to offer the lowest price wins the business, with total revenue generated for the seller from all five Buyers totaling $9,707.50 (for an average price of $194.15), of which $757.50 represents an additional surplus. The Buyers willing to pay a higher price receive the largest discount, and the Sellers who wanted too much got nothing.

TABLE B1
Discount and Surplus for the matching of buyers and sellers as
shown in Table A1.

| | Seller's | | Discount | Surplus to |
|---|---|---|---|---|
| Intention | Price | Price Paid | Per Buyer | Seller 3 |
| Intention 1: | $179.00 | $214.50 | $35.50 | 1 × $35.50 = $35.50 |
| 1 @ $250 | | | | |
| Intention 2: | $179.00 | $209.00 | $30.00 | 15 × $30.00 = $450.00 |
| 15 @ $239 | | | | |
| Intention 3: | $179.00 | $197.00 | $18.00 | 4 × $18.00 = $72.00 |
| 4 @ $215 | | | | |
| Intention 4: | $179.00 | $189.00 | $10.00 | 20 × $10.00 = $200.00 |
| 20 @ $199 | | | | |
| Intention 5: | $179.00 | $179.00 | $0.00 | 10 × $0 = $0.00 |
| 10 @ $179 | | | | |

If the method of computation (or some approximation of the principle behind them) is publicized to users, then Buyers will have an incentive to bid higher (and not offer ridiculous bids at cut rate prices) and Sellers will attempt to offer prices that are lower, with the expectation they may receive an additional surplus once the sales close.

A disadvantage, however, of always giving business to the Seller with the lowest offer is that Sellers may then offer ridiculously low prices, perhaps at prices reflecting a loss, under the hope that they would undercut competitors, win the business and make up for the loss with the additional surplus.

Some embodiments may attempt to avoid this by comparing bids with a known reference price, perhaps stored in the Item Database. In another embodiment of the invention, a matching algorithm as illustrated in Table A2 may be employed. Buyers are matched with a combination of Sellers with the low prices, with as many sales as possible being assigned to the second lowest offer by a Seller, in this case, Seller 2.

TABLE A2
A second example of matching Intentions and Seller's Offers as presented in
Table A for the hypothetical sale of 50 cameras.

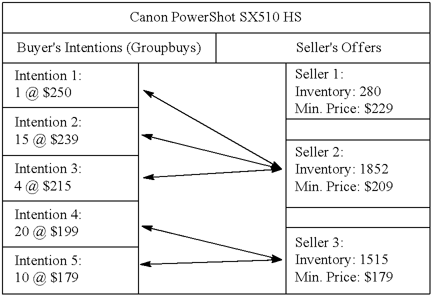

Table B2 illustrates the results. The discounts and surpluses for the transactions involving Seller 3 are unchanged, but the discounts and surpluses for transactions involving Seller 2 are lower. Hence, Seller 3, offering a cut-rate price, now receives $5,570.00 (for 30 cameras, or 60% of the cameras sold, at an average price of $185.67), while Seller 2 receives $4,437.50 (for the remaining 20 cameras, or 40% of the business, at a average price of $221.87).

TABLE B2
Discount and Surplus for the matching of buyers and sellers as
shown in Table A2.

| | Seller's | Price | Discount | Surplus to | Surplus to |
|---|---|---|---|---|---|
| Intention | Price | Paid | Per Buyer | Seller 2 | Seller 3 |
| Intention 1: | $209.00 | $229.50 | $20.50 | 1 × $20.50 = $20.50 | |
| 1 @ $250 | | | | | |
| Intention 2: | $209.00 | $224.00 | $15.00 | 15 × $15.00 = $225.00 | |
| 15 @ $239 | | | | | |
| Intention 3: | $209.00 | $212.00 | $3.00 | 4 × $3.00 = $12.00 | |
| 4 @ $215 | | | | | |
| Intention 4: | $179.00 | $189.00 | $10.00 | | 20 × $10.00 = $200.00 |
| 20 @ $199 | | | | | |
| Intention 5: | $179.00 | $179.00 | $0.00 | | 10 × $0 = $0.00 |
| 10 @ $179 | | | | | |

However, the total revenue for all transactions when matched this way is $10,007.50—larger by $300 (or about 3.1%) than the case presented in Table B1. If the business managing the transaction is paid on a commission of the total sales volume, this second example may represent an embodiment in which Buyers still get discounts, Sellers still get surpluses, but the revenue to the site managing the transactions is also increased.

In some embodiments of the invention, a transaction fee or commission amount may also be collected for the management of the transactions. This commission may be a fixed transaction amount for each sale, such as $4.99, or a percentage, such as 3% or 5%, collected on each sale, or a percentage, such as 25%, collected on the surplus/discount for each sale. In some embodiments of the invention, some combination of fixed fees and percentages, or some other transaction fee according to a pre-determined schedule, may be collected for each sale. These commissions may be paid by the Seller, or in equal amounts by the Buyer and Seller, or paid entirely by the Buyer.

### III.2. Other Matching Approaches

Turning now to the data presented in Table C, which presents three of the Intentions from Table A for a total of 15 cameras, and 3 Seller's Offers. In the case of Table A, each Seller had an abundance of product, but in this case, the inventory each Seller has to offer is far more limited. The price for Seller 1 in this example is also significantly larger, almost a full list price.

TABLE C
An example of Intentions and Seller's Offers for the hypothetical
purchase of cameras when the Sellers have limited inventory.
Canon PowerShot SX510 HS

| Buyer's Intentions (Groupbuys) | Seller's Offers |
|---|---|
| Intention 1: | Seller 4: |
| 1 @ $250 | Inventory: 13 |
| | Min. Price: $249 |
| Intention 3: | Seller 5: |
| 4 @ $215 | Inventory: 4 |
| | Min. Price: $209 |
| Intention 5: | Seller 6: |
| 10 @ $179 | Inventory: 12 |
| | Min. Price: $179 |

The information can be represented in a matrix, matching Buyers and Sellers. A representative Matrix is illustrated in Table C1.

TABLE C1
An Matrix representation of the Price Matching data in Table C.

| | Intention 1: | Intention 3 | Intention 5 |
|---|---|---|---|
| Price Match | 1 @ $250 | 4 @ $215 | 10 @ $179 |
| Seller 4: | YES | X | X |
| 13 @ $249 | | | |
| Seller 5: | YES | YES | X |
| 4 @ $209 | | | |
| Seller 6 | YES | YES | YES |
| 12 @ $179 | | | |

An “X” represents that the Seller's price is greater than what the Buyer is willing to pay.
A “YES” indicates the Seller's price is less than or equal to what the Buyer is willing to pay.

From a price point of view, both Sellers 5 and 6 can fulfill Intention 3, whereas Intention 5 can currently only be filled by Seller 6, while Intention 1 can be filled by any of the three Sellers. Some matches are therefore straightforward: Seller 6, for example, is the only candidate to fulfill Intention 5.

However, inventory is another factor in order fulfillment. Seller 6 can meet the price conditions of all three Intentions, but only has an inventory of 12 cameras. Therefore, Intentions 1 and 3 (totaling 5 cameras) could be fulfilled, or Intentions 1 and 5 (totaling 11 cameras) could be fulfilled, but fulfilling Intentions 1, 3 and 5 (totaling 15 cameras) is not possible. Likewise, Seller 5, with an inventory of 4 cameras, can fulfill either Intention 1 or Intention 3, but not both (since both together total 5 cameras).

In various embodiments of the invention, a number of different matching algorithms with different weights assigned to different factors may be used to address situations such as this.

If the goal is the immediate fulfillment of all orders, then greater weight will be placed on the distribution of inventory to fulfill the maximum number of intentions. For the example described above, the assignments shown below in Table C2 allow all orders in Table C to be immediately fulfilled.

TABLE C2
An example of matching Intentions and
Seller's Offers for the hypothetical purchase of a
camera when the Sellers have limited inventory.

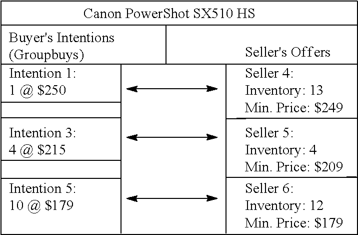

If average prices between Buyer's bids and Seller's offers are again used, a total “surplus” of only $12.50 is achieved, as illustrated below in Table C3.

TABLE C3
An example of inventory assignment for the hypothetical purchase of a Canon PowerShot
SX510 HS, using the assignment of Table C2.

| Seller | Buyer | Transaction | Seller Surplus |
|---|---|---|---|
| Seller 4 | Intention 1 | 1 @ $249.50 = $249.50 | 1 × ($249.50 − $249.00) = $0.50 |
| Seller 5 | Intention 3 | 4 @ $212.00 = $848.00 | 4 × ($212 − $209) = $12.00 |
| Seller 6 | Intention 5 | 10 @ $179.00 = $1,790.00 | 10 × ($179 − $179) = $0 |

However, in some embodiments, other algorithms may employed that place weight on maximizing the surpluses for the Sellers (i.e. matching a Seller willing to take a lower price with a Buyer willing to pay a higher price), and, if the time specified for shipment is flexible, then the system may also provide a high-margin Seller an option of finding three more cameras in a certain pre-determined time period. If, in the above example, Seller 6 is given the option of fulfilling all Intentions at the average between the Seller's bid and Seller 3's asking price of $179, a larger surplus of $107.50 will result:

TABLE C4
An example of inventory assignment for the hypothetical purchase of a Canon PowerShot
SX510 HS, assigning all sales to Seller 6.

| Seller | Buyer | Transaction | Seller Surplus |
|---|---|---|---|
| Seller 6 | Intention 1 | 1 @ $214.50 = $214.50 | 1 × ($214.50 − $179.00) = $35.50 |
| Seller 6 | Intention 3 | 4 @ $197.00 = $788.00 | 4 × ($197 − $179) = $72.00 |
| Seller 6 | Intention 5 | 10 @ $179.00 = $1,790.00 | 10 × ($179 − $179) = $0 |

And, if Seller 6 is allowed to fulfill all Intentions at their stated value instead of an average (i.e. fulfilling all stated Intentions as bid, but not giving any additional discount), Seller 6 will have an even larger surplus of $215.00, as illustrated in Table C5.

TABLE C5
An example of inventory assignment for the hypothetical purchase of a Canon PowerShot
SX510 HS, assigning all sales to Seller 6 and eliminating additional discounts for Buyers.

| Seller | Buyer | Transaction | Seller Surplus |
|---|---|---|---|
| Seller 6 | Intention 1 | 1 @ $250.00 = $250.00 | 1 × ($250 − $179.00) = $71 |
| Seller 6 | Intention 3 | 4 @ $215.00 = $860.00 | 4 × ($215 − $179) = $144 |
| Seller 6 | Intention 5 | 10 @ $179.00 = $1,790.00 | 10 × ($179 − $179) = $0 |

Whether system containing an embodiment of the invention comprising such an algorithm favorable to Sellers without the corresponding discount to Buyers would be acceptable to Buyers is a question of marketing.

Computations of commissions and fees for the organizer of the system may also be a factor in the implementation of the algorithms for embodiments of the invention. If commissions are based on the total sales volume (e.g. 5%, paid by the Seller), the fees charged by the system will be simply based on the total transaction amounts, and there is no incentive to search for higher profits for the sellers. For such as situation, the algorithm employed by the system would maximize the total transaction sales amounts. On the other hand, if the commissions paid to the system are based on the Seller's “surplus” amounts, there is an incentive to employ an algorithm that maximizes the total Sellers' surpluses.

Alternatively, some embodiments may employ algorithms that provide greater weight to giving Buyers the best bargains (i.e. matching a Seller willing to take a lower price with a Buyer willing to pay a lower price). In this case, the algorithm employed by the system for matching would attempt to drive the total Sellers “surplus” to be as close to $0 as possible.

In these embodiments of the invention as disclosed in this section, Buyers only provide statements of Intentions, and are not allowed to “shop” among various Sellers to find a match on their own. There are a number of prior art online shopping sites that allow such a self-driven transaction to take place. Likewise, Sellers only see the various Intentions as submitted by Buyers—Sellers can't see the conditions and limitations for offers and inventory provided by other Sellers. However, most embodiments of the system according to the invention have access to both details about the Buyers' Intentions as well as the Seller's price and sales inventory information. In some embodiments of the invention, various criteria for the seller, such as the ability to deliver on time, and the Seller's historical performance, such as ratings left by buyers in previous transactions, may also be a factor used in the execution of the matching algorithm.

### III.3. Intention Standardization

In embodiments where a product is selected from a displayed listing of objects, and the only variable that is entered is the Buyer's Price for that item, creating a Groupbuy is straightforward. However, purchasing an item may encompass more than simply ordering a single item and assigning a price to it. For example, it may be possible to click on a graphic image of a camera, and then be provided with a screen that allows the selection additional peripheral items, such as having a flash, the relative amounts of optical vs. digital zoom, etc.

However, if the user simply wants a “camera” without limitation to a particular brand or to a particular set of features, many more potential matches may occur. Algorithms to match Buyers and Sellers in this case may be considerably more complex. Language may need to be added to certain end-user License Agreements implicit or explicit in the completion of the transaction by the system that insure that the creation of an Intention with no brand identified may be fulfilled by any Seller offering any brand that meets the specified terms of the Intention.

This may be especially complex if two Buyers each want a particular item (e.g. a Dishwasher) at the same price, but one wishes to have an extended warranty lasting several years, while the other does not. The question arises whether these two Intentions should be pooled into a Groupbuy, with offer of a Service Contract also offered later by the Seller, or whether it should be treated as an integral part of the Intention, and therefore these two offers for an identical product at an identical price would be deemed forever different. In some embodiments, additional Service Contracts and Extended Warranties will be treated simply as product features, along with other product specifications. In some embodiments, Service Contracts and Extended Warranties may be treated as additional products, which need their own Intentions as well.

In some embodiments of the Invention, an Intention may comprise a set of products that include various options at additional cost. For example, an Intention to purchase a camera may also comprise an intention to purchase, for example, a particular lens for the camera (which are now often sold separately), or other auxiliary features or peripheral products, such as camera flashes, camera straps, camera tripods and the like. Embodiments that allow users to create Intentions that also select these often highly profitable peripherals may be designed by those skilled in art. In some embodiments, “Intention Sets” may also be created, in which multiple Intentions are identified as linked (such as an Intention for a camera and also an Intention for a camera flash) but may be individually fulfilled by different Sellers.

### III.4. Seller Preferences

In some embodiments of the invention, although Sellers will not typically have the ability to select individual Buyers, Sellers may have the additional ability to express certain criteria for Buyer qualifications. These may be entered as preferences in the Seller's Profile, and in some embodiments of the invention, the data in the Sellers' profile and the Buyers' profiles will be consulted and considered in the completion of a match between Buyers and Sellers.

The criteria entered may include, but not be limited to, a stated preference for Sellers to have a Buyer's confidence rating to be above a certain score (e.g. over 95% reliable), or to have a credit score over a certain rating (e.g. FICO scores over 700), or to have shipping addresses within a certain geographic range (e.g. within the 48 United States, or in a certain postal code range). Other criteria that a Seller may wish to have in a Buyer will be known to those skilled in the art.

### III.5. Social Shopping

In addition to the basic matching between Buyers and Sellers, some embodiments of the invention may provide an incentive system for Buyers. In some embodiments, these incentives may be modeled after commonly used formats for various social networking websites.

As an example, the first Buyer to create an Intention may be flagged within the system as a tentative “Organizer”, as was illustrated in FIG. 8. If other Buyers then identify the same item as an Intention, and these are pooled into a Groupbuy, the “Organizer” may receive a reward for initiating a Groupbuy, such as a number of points awarded through a point system. Points in the system, once accumulated, may in turn be exchanged for a bonus, such as a free prize or a discount by a certain percentage (e.g. 2%-5%) on the item in the Groupbuy. In some embodiments, the reward may be a percentage of the commission discussed above, which may in turn be based on the total sales amount, or on the total profit generated, or the total discount created for bargain shoppers, or other criteria determined by the algorithms matching Buyers and Sellers.

In some embodiments, the option for a Buyer to simply join an Intention, adding their statement of their desire to purchase directly to a Groupbuy, may be offered, without the need for an algorithm within the system to recognize that two Intentions are matched. In these embodiments, the list of Intentions will be made visible to the Buyers, perhaps as simply listing them as “Groupbuys” and not simply Intentions, and a “Join this Groupbuy” button, as illustrated in FIG. 8, may be provided on screen to allow the Intentions to be browsed and selected by a Buyer.

In some embodiments, these listed “Groupbuys” may be searchable by a search engine provided to work in tandem with the software.

In some embodiments, a comments section may also be provided, in which various Users may add notes or comments, such as suggestions on specifications, or impressions of product quality. In some embodiments, permission to add a comment may be allowed for only Users who have joined the Intention. In some embodiments, permission to add a comment may be allowed for any registered user.

### III.6. Buyer Preferences

In some embodiments of the invention, Buyers may have the additional ability to express certain criteria for Seller qualifications. These may be entered as preferences in the Buyer's Profile, or in the Intention itself, or as a Comments section, and in some embodiments of the invention, the data in the Sellers' profile and the Buyers' profiles will be considered in the completion of a match between Buyers and Sellers.

The criteria entered may include, but not be limited to, a stated preference for Sellers to have no records of unreliable delivery, or to guarantee a certain delivery date; or to have been in business since a certain date. Preferences that Sellers do business within certain countries (avoiding customs issues) or states (for example, wine may only be shipped between certain states within the United States) and the like may also be entered. A ratings system for Buyers to rate their experiences of a Seller may also be used in the completion of a match between Buyers and Sellers.

### III.7. Auxiliary Marketplace

In some situations, an Intention may be entered into the system but no other intentions found that allow the automatic creation of a Groupbuy. However, even if there are no matches that allow pooling of Intentions, in some embodiments of the invention, individual Sellers may have an interface that allows them to manually search the Intention Database to look for interested Buyers, and to make a direct offer to the Buyer. In these embodiments, the main implementation will additionally comprise options that allow a traditional one-to-one market to also function along side the automatic matching of buyers and sellers.

### III.8. Alternative Input Format

In some embodiments of the invention, instead of clicking on representations of consumer items to “select” specific items to form an Intention, an alternative input mode may be offered in which the user enters information into a text field, and software is executed that analyzes this text to generate an Intention.

In some embodiments, this may be enabled by providing a button labeled, for example, “Create Freeform Intention”. Once this button has been clicked, a screen enabling text input field is presented to the Buyer. The Buyer may then enter text, such as:
I'm looking for a camera that is rugged and costs less than $200. I would like it to have a built-in flash and be black in color. I also want a 2 year warranty. I need this shipped to Paso Robles, Calif.
   or
I need to hire a moving company to pack all our household goods and transport them from Dallas, Tex. to Williston, N. Dak. We now have a 2885 sq ft 3 br 2 ba house that needs everything packed. I want to pay no more than $3500 for the move.

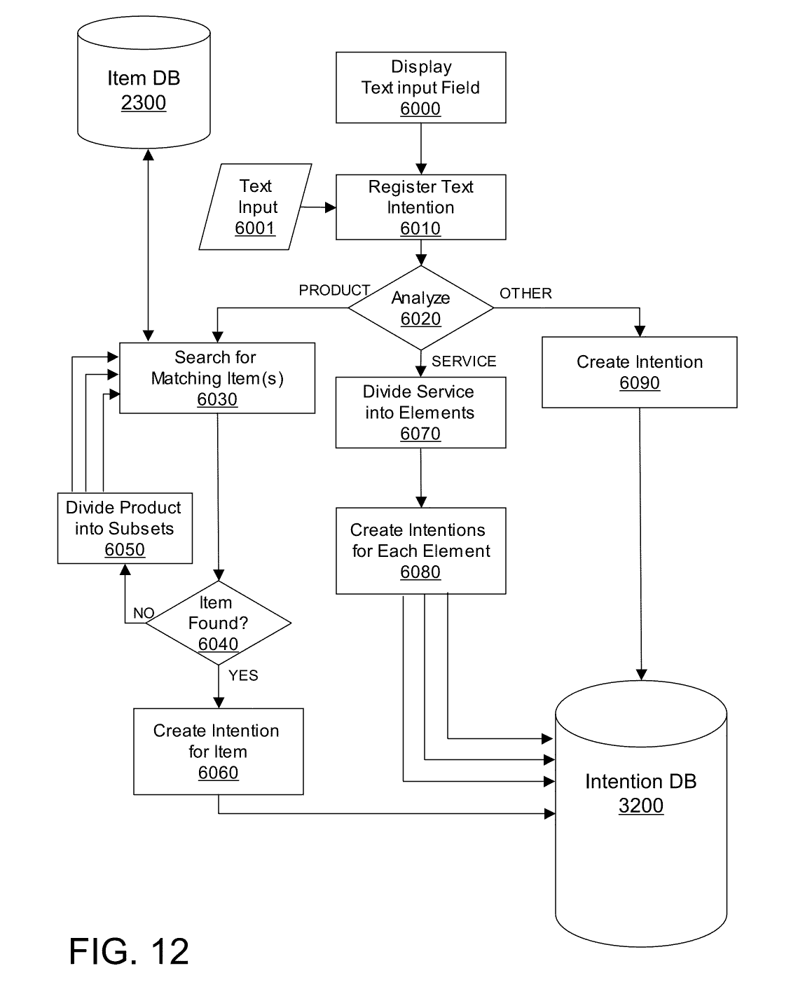

The process used to analyze the Intention is illustrated in FIG. 12, and may be described as a “quantization” process. As illustrated, initially, the text input field is displayed to the user in the first step 6000, and the user generates text 6001 and inputs it into the field. In the next step, the system registers 6010 the text “Intention” and submits the text to an analysis 6020, in which the text is analyzed to identify if the Intention relates to a product, a service, or some other category.

If the analysis is does not recognize the text as representing either a product or a service, then the system may proceed to a step 6090 in which an Intention is created in the Intention Database 3200 that exactly contains the text as submitted.

However, if the analysis recognizes that the text relates to a product, then the system may then execute a step 6030 in which the software looks into the contents of the Item Database 2300 to see if there is a match to an already stored item. If a match is found in the next step 6040, the software may proceed to create an Intention 6060 to be stored in the Intention Database. If a match is not found, code may be executed to parse the text 6050 of the product Intention into subsets (such as, for example, dividing a stated text desire for a camera with flash and lens into separate component Intentions for a camera, a flash, and a lens). The search step 6030 of the Item database 2300 is then executed for each of the parsed subsets, and, if a match is found in the reiteration of the next step 6040, an Intention is created 6060 and placed in the Intention database 3200.

Likewise, if the analysis recognizes that the text relates to a service, then the system may then execute a step 6070 in which the software parses the service into individual service elements (such as, for example, doing a set of predefined chores, or providing a service warranty) The software may then proceed to create an Intention 6080 for each service element to be stored in the Intention Database 3200.

This process may be executed using additional data used to recognize elements in a text description and parse them into smaller elements. For example, the paragraph requesting help moving above may be broken down into the distance to be traveled, the approximate weight of household belongings for a residence of this size, etc. Insurance requirements, packaging requirements, scheduling requirements, and the like may be determined from a look-up table stored with this data. This database may be built up from an expert system created from those with specialized knowledge about moving, or could be the product of a machine learning program designed to recognize patterns in previous matches regarding moving, or some combination thereof. Variations on systems for parsing data entries in this manner will be known to those skilled in the art.

### III.9. Group Buyers

In some embodiments of the invention, a Buyer may create an account to represent the Intentions of a group that is defined offline, such as a social group or a club devoted to a common interest. The “User” in this case may, for example, represent the First Methodist Church of Cedar Rapids, or the Stanford Fencing Club. An Intention may therefore reflect the wishes of a group of people, and be encoded within the Buyers Database or may be linked to a Facebook page for the group to indicate that the single entered Intention already represents a pooled sale opportunity.

The Intentions of this “pre-pooled” Buyer may then be combined with other Groupbuys formed by individuals or other groups. The data structures in such a system may be configured to allow a Buyer to be identified with two or more identifiers, one that allows them to enter Intentions as an individual, the other to indicate membership in a registered group.

### III.10. Anonymous Buyers and Information

In some embodiments of the invention, although prices in Intentions may be visible to others, the actual final price paid will generally be kept anonymous, and be known only to buyers and sellers engaged in the GroupBuy. In some embodiments of the invention, a Buyer may also wish to remain anonymous. The system in this case may be configured to allow a Buyer to be identified with at least two sets of identifiers, one known only to the system itself, which contains the detailed identification information, and the other shared with the Sellers and other Buyers at large. A Groupbuy comprising anonymous Buyers could then be created, and the Seller could consider this information in evaluating whether to sell to the Groupbuy. deliver of goods and services would be handled in such embodiments using an anonymous voucher system, with the voucher taking the equivalent characteristics of cash or bitcoins, with no identifying information linking it to the personal information of the Buyer.

### IV. Embodiments on Computers

Although the embodiments disclosed so far comprise the use of a web interface for exploring and entering buyer's intentions, as was illustrated in FIG. 1, many computers connected to the Internet may also be used for interacting with this system, for example, smartphones enabled with Wi-Fi, SmartTVs with wireless internet connections, etc. Likewise, the central computer system 700 as illustrated in FIG. 1 may comprise one or more standard computer systems of the sort illustrated in FIG. 13.

FIG. 13 illustrates a block diagram of an exemplary computer system that can serve as a platform for portions of embodiments of the present invention. Computer code in programming languages such as, but not limited to, C, C++, C#, Java®, Javascript®, Objective C®, Boo, Lua, assembly, Fortran, APL, etc., and executed in operating environments such as Windows® and all its variants, Mac OS-X®, iOS®, Android®, Blackberry®, UNIX®, Linux®, etc., can be written and compiled into a set of computer or machine readable instructions that, when executed by a suitable computer or other microprocessor based machine, can cause the system to execute the method of the invention.

One embodiment of such a computer system 7000 comprises a bus 7007 which interconnects major subsystems of computer system 7000, which typically comprises: a central processing unit (CPU) 7001; a system memory 7005 (typically random-access memory (RAM), but which may also include read-only memory (ROM), flash RAM, or the like); an input/output (I/O) controller 7020; one or more data storage systems 7050, 7051 such as an internal hard disk drive or an internal flash drive or the like; a network interface 7700 to an external network 7770, such as the Internet, a fiber channel network, or the like; and one or more drives 7060, 7061 operative to receive computer-readable media (CRM) such as an optical disk 7062, compact-disc read-only memory (CD-ROM), compact discs (CDs), floppy disks, universal serial bus (USB) thumbdrives 7063, magnetic tapes, etc.

The computer system 7000 may also comprise: a keyboard 7090; a mouse 7092; and one or more various other I/O devices such as a trackball, an input tablet, a touchscreen device, an audio microphone and the like. These I/O devices may be internal to the system, as is found, for example, if the computer system 7000 is a laptop, or may be external to the system, as is found in typical desktop configurations. The computer system 7000 may also comprise a display device 7080, such as a cathode-ray tube (CRT) screen, a flat panel display or other display device; and an audio output device 7082, such as a speaker system. The computer system 7000 may also comprise an interface 7088 to an external display 7780, which may have additional means for audio, video, or other graphical display capabilities for remote viewing or analysis of results at an additional location.

Bus 7007 allows data communication between central processor 7000 and system memory 7005, which may comprise read-only memory (ROM) or flash memory, as well as random access memory (RAM), as previously noted. The RAM is generally the main memory into which the operating system and application programs are loaded. The ROM or flash memory can contain, among other code, the basic input/output system (BIOS) that controls basic hardware operation such as the interaction with peripheral components. Applications resident within computer system 7000 are generally stored on storage units 7050, 7051 comprising computer readable media (CRM) such as a hard disk drive (e.g., fixed disk) or flash drives.

Data can be imported into the computer system 7000 or exported from the computer system 7000 via drives that accommodate the insertion of portable computer readable media, such as an optical disk 7062, a USB thumbdrive 7063, and the like. Additionally, applications and data can be in the form of electronic signals modulated in accordance with the application and data communication technology when accessed from a network 7770 via network interface 7700. The network interface 7700 may provide a direct connection to a remote server via a direct network link to the Internet via an Internet PoP (Point of Presence). The network interface 7700 may also provide such a connection using wireless techniques, including a digital cellular telephone connection, a Cellular Digital Packet Data (CDPD) connection, a cellular system following G3 or G4 protocols, a digital satellite data connection or the like.

Many other devices or subsystems (not shown) may be connected in a similar manner (e.g., document scanners, digital cameras, etc.). Conversely, all of the devices shown in FIG. 13 need not be present to practice the present disclosure. In some embodiments, the devices and subsystems can be interconnected in different ways from that illustrated in FIG. 13.

Code representing software instructions to implement embodiments of the present invention can be stored on one or more computer-readable storage media such as: the system memory 7005, internal storage units 7050 and 7051, an optical disk 7062, a USB thumbdrive 7063, one or more floppy disks, and the like. The operating system provided for computer system 7000 may be any one of a number of operating systems, such as UNIX®, Linux®, MS-DOS®, MS-WINDOWS®, OS-X® and the like.

Moreover, regarding the signals described herein, those skilled in the art will recognize that a signal can be directly transmitted from one block to another, between single blocks or multiple blocks, or can be modified (e.g., amplified, attenuated, delayed, latched, buffered, inverted, filtered, or otherwise modified) by one or more of the blocks. Furthermore, the computer as described above may be constructed as any one of, or combination of, computer architectures, such as a tower, a desktop, a laptop, a workstation, or a mainframe (server) computer. The computer system may also be any one of a number of other portable computers or microprocessor based devices such as a mobile phone, a smartphone, a tablet computer, an iPad®, an e-reader, or wearable computers such as smart watches, intelligent eyewear and the like.

For the embodiments of the invention as presented in this Application using such a computer 7000, software code representing the equivalent of the databases comprising representations disclosed herein may be read from storage devices 7050 or 7051 within the computer system 7000, or from CRM such as an optical disk 7062 or USB thumbdrive 7063, and executed using the CPU 7001 and system memory 7005. The user options may be presented on either an internal display 7080 or an external display 7780 connected by means of an interface 7088, and the user may make “selections” using a keyboard 7090 and/or mouse 7092 synchronized with a graphical user interface (GUI) constructed within the software to allow coordination of the options shown on the available displays 7080 or 7780.

### V. Hardware and Software

Accordingly, embodiments of the present invention may be encoded in suitable hardware and/or in software (including firmware, resident software, microcode, etc.). Furthermore, embodiments of the present invention may take the form of a computer program product on a non-transitory computer readable storage medium having computer readable program code comprising instructions encoded in the medium for use by or in connection with an instruction execution system. Non-transitory computer readable media on which instructions are stored to execute the methods of the invention are therefore in turn embodiments of the invention as well. In the context of this Application, a computer readable medium may be any medium that can contain, store, communicate, propagate, or transport the program for use by or in connection with the instruction execution system, apparatus, or device.

The computer readable medium may be, for example but not limited to, an electronic, magnetic, optical, electromagnetic, infrared, or semiconductor system, apparatus, or device. More specific examples (a non-exhaustive list) of a computer readable media would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM).

### VI. Limitations

With this application, several embodiments of the invention, including the best mode contemplated by the inventors, have been disclosed. It will be recognized that, while specific embodiments may be presented, elements discussed in detail only for some embodiments may also be applied to others.

While specific materials, designs, configurations and fabrication steps have been set forth to describe this invention and the preferred embodiments, such descriptions are not intended to be limiting. Modifications and changes may be apparent to those skilled in the art, and it is intended that this invention be limited only by the scope of the appended claims.

What is claimed is:

1. A computer-implemented system for online commerce, comprising means for the execution of the following steps:
analyzing by a computer a first database comprising information corresponding to intentions of one or more buyers to purchase at least one item represented by data in a database of items;
analyzing by a computer a second database comprising information corresponding to information about sellers; and
executing by a computer a matching algorithm that analyzes whether the intentions of the one or more buyers can be fulfilled by the sellers; and
outputting by a computer the results of the matching algorithm.

2. The computer-implemented system of claim 1, further comprising means for the execution of the step of:
generating by a computer at least one purchase order for the at least one item, in which the at least one purchase order relates data about at least one buyer to data about at least one seller.

3. The computer-implemented system of claim 1, further comprising means for the execution of the steps of:
generating by a computer a plurality of purchase orders for the at least one item;
in which each of the purchase orders relates data about at least one buyer to data about at least one seller selected from a plurality of sellers.

4. The computer-implemented system of claim 2, in which:
the generation by a computer of at least one purchase order comprises the creation of a legally binding contract according to predetermined contract terms between the at least one buyer and the at least one seller; and
further comprising means for the execution of the step of:
outputting by a computer
a statement of at least some of the terms and conditions of the contract.

5. The computer-implemented system of claim 2, further comprising means for the execution of the steps of:
receiving data representing a payment by a buyer;
generating by a computer data representing one or more vouchers for the at least one item associated with the purchase order; and
outputting by a computer
an electronic transmission related to the creation of the voucher.

6. The computer-implemented system of claim 5, in which
the payment by the buyer corresponds to a payment in full for the at least one item.

7. The computer-implemented system of claim 5, in which
the payment by the buyer corresponds to a payment representing a predetermined percentage of the payment in full for the at least one item.

8. The computer-implemented system of claim 1, in which
the matching algorithm prioritizes the calculation of a quantity related to at least one of the variables selected from the list consisting of:
the total transaction amount, the percentage of commission,
the seller's profit, and the buyer's discount.

9. The computer-implemented system of claim 1, in which
the matching algorithm includes a computation based on predetermined criteria related to data on seller performance stored in the second database comprising information about sellers.

10. The computer-implemented system of claim 9, in which
the predetermined criteria are related to a seller's ability to deliver an item on time.

11. The computer-implemented system of claim 1, in which
the matching algorithm includes a computation based on predetermined criteria related to buyer qualifications previously identified by a seller.

12. The computer-implemented system of claim 11, in which
the buyer qualifications are selected from the list consisting of:
the buyer's profile in a third database comprising buyer information,
the buyer's reliability score, the buyer's credit score,
the buyer's shipping address, and the buyer's postal code.

13. A non-transitory computer readable medium for use in an electronic data processing system, the non-transitory computer readable medium having encoded upon it a data structure corresponding to an Intention, created by executing the steps of:
sending by a computer data representing one or more items in an item database to a remote display apparatus;
receiving input data from a remote input apparatus that corresponds to the selection of one of the items;
sending by a computer data about the selected item to the remote display apparatus;
receiving purchase input data from a remote input apparatus designated to create a data structure corresponding to an intention to purchase the selected item,
in which the purchase input data comprises data corresponding to the selected item, at least one buyer, and a maximum price to be paid; and
storing by a computer the received purchase input data in a non-transient database.

14. The non-transitory computer readable medium comprising a data structure of claim 13, in which
the purchase input data additionally comprises data corresponding to a delivery location.

15. The non-transitory computer readable medium comprising a data structure of claim 13, in which
the purchase input data additionally comprises data corresponding to proof of payment by the at least one buyer.

16. The non-transitory computer readable medium comprising a data structure as described in claim 13, created by additionally executing the steps of:
sending by a computer data representing the created data structure to a second remote display apparatus;
receiving second purchase input data from a second remote input apparatus corresponding to a second Intention to purchase the selected item associated with the data structure;
in which the second purchase input data comprises data corresponding to the selected item and at least a second buyer; and
augmenting the created data structure in the database by additionally storing the second purchase input data in the non-transient database.

17. A computer-implemented method of matching buyers and sellers, comprising:
creating a first data structure on a computer readable medium corresponding to an Intention according to the description of claim 13;
reading by a computer at least the item and price information stored in said first data structure;
reading by a computer one or more entries in a database
representing data related to at least one seller's price for the item;
comparing by a computer the price data in the first data structure with the data related to the at least one seller's price; and
generating by a computer a second non-transitory data structure
on a computer readable medium representing a purchase order comprising
data related to at least one buyer as stored in said first data structure,
data related to at least one seller as stored in said second data structure, and
data representing one price.

18. The computer-implemented method of claim 17, further comprising:
automatically transmitting information related to the generation of said second non-transitory data structure representing a purchase order to:
a predetermined destination related to at least one buyer, and
a predetermined destination related to the seller.

19. The computer-implemented method of claim 18, in which
at least one of the predetermined destinations comprises an e-mail addresses.

20. The computer-implemented method of claim 18, further comprising:
receiving by a computer data related to a payment transaction corresponding to at least one buyer;
generating by a computer a third non-transitory data structure on a computer readable medium representing a voucher comprising
data related to the payment made by the buyer,
data related to the seller,
data representing one price; and
outputting automatically by a computer
an electronic transmission related to the creation of said third data structure representing a voucher.

21. The computer-implemented method of claim 17, further comprising:
receiving by a computer data related to an inquiry from a transmission source associated with a listing in an electronic database of sellers;
outputting by a computer data related to at least one data structure corresponding to an Intention; and
receiving by a computer data related to a bid to fulfill at least a portion of said Intention; and
storing the data related to a bid
in an electronic database representing information related to at least one seller's inventory and seller's price for the item.

22. A non-transitory computer readable medium for use in an electronic data processing system, said medium having encoded upon it instructions executable by the data processing system to perform process steps comprising:
analyzing by a computer a first database comprising information corresponding to intentions of one or more buyers to purchase at least one item represented by data in a database of items;
analyzing by a computer a second database comprising information corresponding to information about sellers; and
executing by a computer a matching algorithm that analyzes whether the intentions of the one or more buyers can be fulfilled by the sellers;
outputting by a computer the results of the matching algorithm;
generating by a computer at least one purchase order for the at least one item, and in which the at least one purchase order relates data about at least one buyer to data about at least one seller;
receiving data representing a payment by a buyer;
generating by a computer data representing one or more vouchers for the at least one item associated with the purchase order; and
outputting by a computer
an electronic transmission related to the creation of the voucher.

23. A non-transitory computer readable medium for use in an electronic data processing system, said medium having encoded upon it instructions executable by the data processing system to perform process steps comprising:
creating a first data structure on a computer readable medium corresponding to an Intention according to the description of claim 13;
reading by a computer at least the item and price information stored in said first data structure;
reading by a computer one or more entries in a database representing data related to at least one seller's price for the item;
comparing by a computer the price data in the first data structure with the data related to the at least one seller's price; and
generating by a computer a second non-transitory data structure on a computer readable medium representing a purchase order comprising
data related to at least one buyer as stored in said first data structure,
data related to at least one seller as stored in said second data structure, and
data representing one price;
automatically transmitting information related to the generation of said second non-transitory data structure representing a purchase order to:
a predetermined destination related to at least one buyer, and
a predetermined destination related to the seller;
receiving by a computer data related to a payment transaction corresponding to at least one buyer;
generating by a computer a third non-transitory data structure on a computer readable medium representing a voucher comprising
data related to the payment made by the buyer,
data related to the seller,
data representing one price; and
outputting automatically by a computer
an electronic transmission related to the creation
of said third data structure representing a voucher.
